(19) United States
(12) Patent Application Publication
(10) Pub. No.: US 2007/0184229 A1
(43) Pub. Date: Aug. 9, 2007

(54) Thermal sheet and apparatus using the same

(75) Inventor: Seok Hwa Jeong, Gyeongsangbuk-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/507,582

(22) Filed: Aug. 22, 2006

(30) Foreign Application Priority Data
Feb. 8, 2006 (KR) 10-2006-0012197

(51) Int. Cl. B32B 33/00; B32B 3/00

(52) U.S. Cl. 428/40.1; 428/172

(57) ABSTRACT

A thermal sheet and an apparatus using the same are provided. The thermal sheet, as embodied, includes a base film including: a plurality of protrusions at a first surface of the base film and extending along a first direction, and a plurality of grooves between two adjacent protrusions as a heat flow path along the first direction; and a thermal layer for thermally conducting and/or radiating heat transferred from the base film, the thermal layer being disposed on the first surface of the base film.

### CROSS-REFERENCE TO RELATED APPLICATIONS

This Nonprovisional application claims priority under 35 U.S.C. §119(a) on Patent Application No. 10-2006-0012197 filed in Korea on Feb. 8, 2006, the entire contents of which are hereby incorporated by reference.

### BACKGROUND OF THE INVENTION

1. Field of the Invention

The present invention relates to a thermal sheet, particularly relates to a thermal sheet as a heat transfer medium of a display device, such as a liquid crystal display device, a plasma display panel, an organic electroluminescent device, a display using light emitting diodes and the like. The thermal sheet of the present invention may be simply attached to any appropriate area of a heat-generating device.

2. Description of the Related Art

The liquid crystal display device (LCD) is an electronic device which converts electrical information to image information by changing the light transmittance of liquid crystals therein and thereby displays the image information.

The LCD is a non-emissive type display device, and thus needs a backlight unit at its back side. The light source generally used in the conventional backlight unit is a cold cathode fluorescent lamp (CCFL), an external electrode fluorescent lamp (EEFL) or a light emitting diode (LED).

In the backlight unit using CCFL as the light source, the temperature of CCFL may rise up to about 80° C. to 90° C. when the backlight unit operates in the LCD, although there are some variations in accordance with the structure of the LCD.

The heat generated from the CCFL may be transferred unevenly to the liquid crystal panel disposed in front of the backlight unit and cause a temperature deviation among the liquid crystal cells. Such temperature deviation of the liquid crystal cells may cause a deviation of the response speed of the liquid crystal cells, which may cause a brightness deviation in the LCD.

The plasma display panel (PDP) is an emissive type display device including a number of discharging cells disposed between a pair of glass substrate. Unlike the LCD, the PDP does not employ a light source to light up the device. However, activating some of the discharging cells for light emission will also generate heat, which raises the temperature of the PDP as a whole. In particular, the heat from the discharging cells are transferred to the glass substrates. However, the heat transferred to the glass substrates cannot be easily conducted in a parallel direction of the surface of the panel mainly due to the poor thermal conductivity of glass material of the substrates.

Consequently, the temperature of the activated discharging cells for luminescence is much higher than the temperature of the inactivated discharging cells. In other words, the temperature of the areas of the panel where the images are displayed rises locally. Such a temperature deviation of the panel may deteriorate the performance of the discharging cells.

In addition, the above-noted heat related problems may also occur in other display devices such as the display device using light emitting diodes (LED) and the organic electroluminescent device (OELD). Theses heat related problems may deteriorate the life-cycle and display quality of the devices.

In this respect, a heat spreading member such as a heat sink or a heat spreader is often provided in those devices to disperse the heat generated therein, and a thermal spreading sheet is additionally provided as a heat transfer medium for transferring the heat generated inside the devices to the heat spreading member. However, the conventional thermal sheet is not efficient to dissipate the heat.

### SUMMARY OF THE INVENTION

An object of the present invention is to provide a thermal sheet to dissipate heat more efficiently.

Another object of the present invention is to provide a thermal sheet which may be used for any display device or any heat-generating device.

Further another object of the present invention is to provide a thermal sheet for dissipating the heat generated in display devices such as LCDs, PDPs, OELDs, or any devices using LEDs, by attaching the thermal sheet to any appropriate surface of the devices.

In one aspect of the present invention, the thermal sheet, as embodied, comprises a base film including: a plurality of protrusions at a first surface of the base film and extending along a first direction, and a plurality of grooves between two adjacent protrusions as a heat flow path along the first direction; and a thermal layer for thermally conducting and/or radiating heat transferred from the base film, the thermal layer being disposed on the first surface of the base film.

In another aspect of the present invention, an apparatus, as embodied, comprises: a heat-generating device which generates heat; a base film for transferring the heat of the heat-generating device, the base film including: a plurality of protrusions at a first surface of the base film and extending along a first direction, and a plurality of grooves between two adjacent protrusions as a heat flow path along the first direction; and a thermal layer for thermally conducting and/or radiating the heat transferred from the base film, the thermal layer being disposed on the first surface of the base film.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1A is a cross-sectional view of a thermal sheet in accordance with an embodiment of the present invention;

FIG. 1B is a cross-sectional view of the thermal sheet of FIG. 1A attached to a heat-generating device in accordance with an embodiment of the present invention;

FIG. 2 is a plane view of the base film of FIG. 1A and a heat dissipater connected to the base film in accordance with an embodiment of the present invention; and

FIG. 3A-3B are cross-sectional views of other embodiments of the base film of FIG. 1A.

### DETAILED DESCRIPTION OF THE ILLUSTRATED EMBODIMENTS

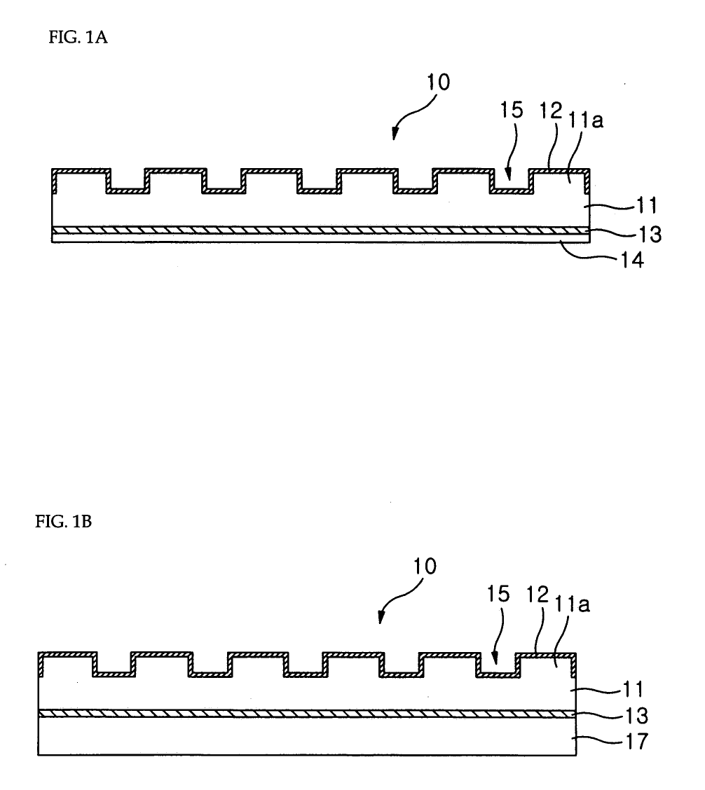

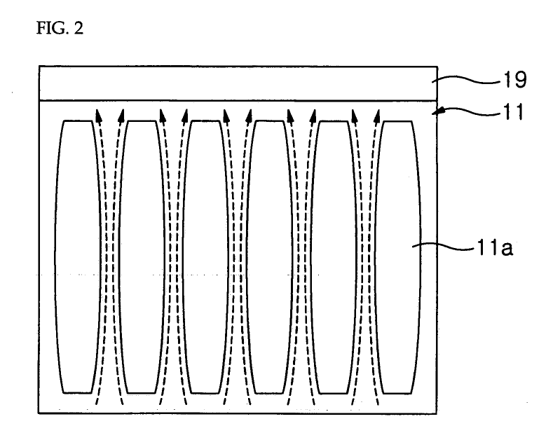

FIG. 1A is a cross-sectional view of a thermal sheet of an embodiment of the present invention, FIG. 1B is a cross-sectional view of the thermal sheet of FIG. 1A attached to a heat-generating device in accordance with an embodiment of the present invention and FIG. 2 is a plane view of the base film of FIG. 1A and a heat sink connected to the base film in accordance with an embodiment of the present invention.

Referring to FIGS. 1A-B and FIG. 2, a thermal sheet 10 according to an embodiment of the present invention comprises a base film 11. The base film 11 has a first surface provided with protrusions 11a which are arranged in a first direction at a predetermined interval and grooves 15 between two adjacent protrusions 11a. The opposite surface to the first surface of the base film 11 in the illustrated embodiment is substantially flat. However, the opposite surface can be configured to other shapes to accommodate the shape of the heat-generating device 17 attached thereto. It is not necessary for the protrusions 11a to be disposed at the same distance. In the illustrated embodiment, the protrusions 11a are spaced apart from each other at the same interval.

The cross-sectional shape of each protrusion 11a may be tetragonal, and each protrusion 11a is spaced apart from another protrusion 11a by a groove 15. In other words, each groove 15 is formed between two adjacent protrusions 11a, and each groove 15 functions as a heat flow path in an apparatus (e.g., display devices) having a heat-generating device 17 so that the heat generated by the heat-generating device can flow along the heat flow path, as shown by dotted lines in FIG. 2. The heat-generating device 17 can be a backlight unit for an LCD device, the discharging cells of a PDP device or an OELD device, the LEDs, etc.

Generally, partially heating a fluid raises the temperature of the fluid as a whole. In particular, the heated portion of the fluid expands in volume and moves upward owing to the increased buoyancy. The upper portion of the fluid, having a lower temperature and a lower density, moves downward instead. This is so-called thermal convection in which heat is transferred by the circulation of the fluid. The thermal convection is one of the important heat transfer mechanisms along with thermal conduction and thermal radiation.

The illustrated thermal sheet applies Bernoulli's principle and efficiently utilizes the thermal convection to expedite heat dissipation. According to Bernoulli's principle, if a perfect flow, i.e., a steady flow with no viscosity of an incompressible fluid passes through a stream tube, the stream tube has two cross section areas S1 and S2, and the flow velocities of the fluid are V1, V2 at the cross section areas S1 and S2 respectively, then the relationship, S1·V1=S2·V2, is established.

As shown in FIG. 2, if the width between any two adjacent protrusions 11a is narrower in a center portion than in both end portions, then the groove 15 functioning as a heat flow/circulation path becomes narrower in the center portion than in the end portions. And the velocity of the heat flow (fluid flow) becomes faster in the center portion in light of Bernoulli's principle. Therefore the heat circulation is accelerated, and the heat dissipation is expedited by the thermal convection.

In order to more efficiently expedite the heat dissipation through the thermal convection, the thermal sheet 10 may be installed in the apparatus in such a manner that the groove 15 is aligned with a direction of the heat flow inside the apparatus.

The base film 11 according to an embodiment of the present invention may be a metal foil, a thermally conductive plastic, or any other thermal conductive materials.

The thermally conductive plastic is a composite material produced by adding a thermal conduction reinforcing agent into an ordinary thermoplastic resin. Recently, the thermally conductive plastic which has a higher thermal conductivity several to several hundred times as large as the ordinary resin has been developed through a new composition and a new mixing process.

The base film 11 can be a copper foil or an aluminum foil. Any kind of metal may also be, however, used if the metal has good thermal conductivity and can be made in the form of a foil.

A thermal layer 12 is disposed on the structured surface of the base film 11, and the thermal conductive layer 12 has thermal conductive particles with good thermal conductivity. The thermal layer 12 absorbs the heat transferred through the base film 11 and thermally conducts the heat to a heat dissipater 19 such as a heat sink or a heat spreader as shown in FIG. 2. Furthermore, the thermal layer 12 may also radiate the heat to a surrounding medium such as air in contact with the thermal layer 12. The thermal conduction and radiation efficiency may be further increased when the thermal layer 12 is formed on the first surface of the base film 11 since the first surface increases the surface area of the thermal layer 12 due to the protrusions 11a and the grooves 15.

In one embodiment, the thermal conductive particles may be selected from the group consisting of Cu, Ag, Al and a mixture thereof. Such metals are preferred for use in the thermal conductive particles since such materials have relatively superior thermal conductivity over other material. Any metallic material having good thermal conductivity may, however, also be used as the thermal conductive particles.

The thermal layer 12 may be formed on the base film 11 by using an appropriate deposition technique such as vapor deposition that deposits a layer by vaporizing the metallic materials through resistance heating under a reduced pressure or electron beam radiation heating, sputtering and the like.

In another embodiment, the thermal layer 12 may be formed by applying onto the base film 11 a liquid mixture of a graphite powder, a binder and a curing agent. The liquid mixture may further include a dispersing agent, a filler and a solvent.

The graphite has, owing to its nature of anisotropic crystallographic structure, directivity to a certain direction with respect to electrical conductivity and thermal conductivity, and a fine processed graphite powder can be used as the thermal conductive particles of the illustrated embodiments.

The binder is an additive to bind the particles of the fine processed graphite powder and unify them. Therefore, the thermal conductive layer 12 will not be easily broken even with a physical impact, owing to the bonding between the particles of the graphite powder by the binder.

A material with superior thermal conductivity and thermal resistance, such as polyester resin, urethane resin, epoxy resin, acryl resin, etc., may be used as the binder. Preferably, the binder is at least one selected from the group consisting of polyester resin having carboxyl end-group, polyester resin having hydroxyl end-group, epoxy resin having oxirane functional group, acryl resin having carboxyl end-group, acryl resin having hydroxyl end-group, acryl resin having GMA end-group and urethane resin.

The curing agent is an additive to enable the liquid mixture to be easily dried and cured. Preferably, the curing agent is at least one selected from a group consisting of epoxy resin curing agent having oxirane group, TGIC (triglycidyl isocyanurate) curing agent having oxirane group, curing agent having isocyanate group, curing agent having blocked isocyanate, curing agent having carboxyl end-group and aliphatic or aromatic curing agent including at least one of epoxide and anhydride reaction group.

The filler is an additive to aid thermal spreading. Preferably, the filler is at least one selected from a group consisting of Al₂O₃, Al, BN and Ag-coated Cu. Cu tends to be easily oxidized during the preparation of the mixture. It is preferable to use Cu in the form of Ag-coated Cu since the oxidized Cu may lower the performance of the mixture. More preferably, the filler is BN.

The dispersing agent is at least one selected from the group consisting of a polyamine amide based material, phosphoric acid ester based material, polyisobutylene, oleic acid, stearin acid, fish oil, ammonium salt of a polycarboxylic acid, sodium carboxy methyl and a mixture thereof.

The solvent is at least one selected from the group consisting of methyl ethyl ketone, ethanol, xylene, toluene, acetone, trichloroethane, butanol, methyl Isobuthyl ketone (MIBK), ethyl acetate (EA), butyl acetate, cyclo hexanone, water, propylene glycol mono methyl ether, MEK, anone and a mixture thereof.

The thermal layer 12 formed of the mixture as described above has good thermal stability and mechanical property (ductility and tensile strength), and thermal stability as well.

An adhesive layer 13 may be disposed on the opposite surface of the base film 11 to its first surface. The adhesive layer 13 allows the thermal sheet 10 to be attached to any appropriate surface of a heat-generating device 17, and also to be simply disposed of when needed. For example, the adhesive layer 13 can be attached and in contact with the backlight unit or the reflector of the backlight unit.

The adhesive layer 13 may be formed by either applying a thermally conductive adhesive with good adhesive strength and thermal conductivity on the surface of the base film 11 or attaching a double-sided adhesive tape to the surface of the base film 11.

The thermal sheet 10 may further comprise a protective sheet 14 disposed on the lower surface of the adhesive layer 13 to protect the adhesive layer 13. The protective layer 14 prevents the adhesive layer 13 from being directly exposed to the air, thereby facilitating handling and storage of the thermal sheet 10. Immediately before the thermal sheet 10 is attached to a display device, the protective layer 14 is removed (see FIG. 1B). Therefore, the surface of the protective layer 14 directly contacting the adhesive layer 13 may preferably have a coating to facilitate the removal of the protective layer 14 from the adhesive layer 13.

As described above, the illustrated thermal sheet 10 may dissipate in the heat generated by a heat-generating device through thermal conduction and radiation of the thermal layer 12 disposed on the first surface of the base film 11, and thermal convection facilitated by the protrusions and grooves of the base film 11 as well.

In the illustrated embodiment of FIG. 1A, the cross-sectional shape of the protrusion 11a is tetragonal However, they can be other cross-sectional shapes of the protrusion 11a to further increase the total surface of the thermal layer, thereby facilitating the thermal conduction and radiation

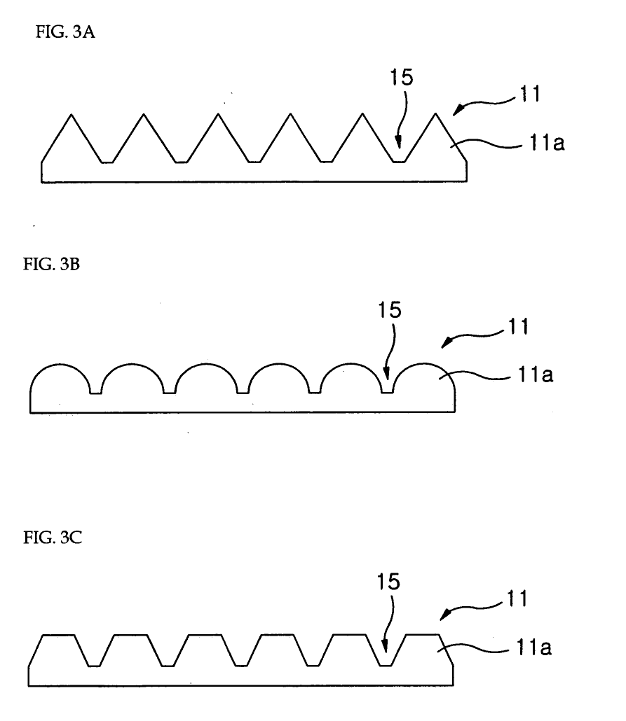

FIG. 3A-3B are cross-sectional views of some other embodiments of the base film of FIG. 1A. In the following embodiments, the same reference numbers will be used to refer to the same or like parts as those in the foregoing embodiment. In addition, detailed descriptions of the identical elements are omitted.

Referring to FIG. 3A-3B, the base film 11 has a first surface provided with protrusions 11a which are arranged in a first direction at the same interval and grooves 15 between two adjacent protrusions 11a. The opposite surface to the first surface of the base film 11 in the illustrated embodiment is substantially flat. As mentioned, the opposite surface can be configured to other shapes to accommodate the shape of the heat-generating device 17 attached thereto. In another embodiment, the plurality of protrusions 11a may be spaced apart by different intervals.

The cross-sectional shape of the protrusion 11a may be a triangle as shown in FIG. 3A, a domed shape as shown in FIG. 3B, and a trapezoid as shown in FIG. 3C. A groove 15 is formed between two adjacent protrusions 11a, and each groove 15 functions as a heat flow/circulation path in an apparatus having a heat-generating device 17 so that the heat generated by the heat-generating device 17 can flow along the heat flow path, as shown by dotted lines in FIG. 2. Since the width between any two adjacent protrusions 11a is narrower in a center portion than in end portions to increase the velocity of the heat (fluid) flow at a center portion, as described above with reference to FIGS. 1A-B and 2, it expedites heat dissipation by the thermal convection.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A thermal sheet comprising:
a base film including:
a plurality of protrusions at a first surface of the base film and extending along a first direction, and
a plurality of grooves between two adjacent protrusions as a heat flow path along the first direction; and
a thermal layer for thermally conducting and/or radiating heat transferred from the base film, the thermal layer being disposed on the first surface of the base film.

2. The thermal sheet of claim 1, wherein a width of a central portion of at least one of the grooves is narrower than a width of an end portion of the at least one of the grooves.

3. The thermal sheet of claim 1, wherein a cross section of at least one of the protrusions has one of a triangular shape, a tetragonal shape, a trapezoidal shape and a domed shape.

4. The thermal sheet of claim 1, wherein the thermal layer has thermal conductive particles therein.

5. The thermal sheet of claim 4, wherein the thermal conductive particles are at least one selected from the group consisting of Cu, Ag, Al and a mixture thereof.

6. The thermal sheet of claim 1, further comprising an adhesive layer disposed on a second surface of the base film opposite to the first surface of the base film.

7. The thermal sheet of claim 6, further comprising a protective layer on the adhesive layer to protect the adhesive layer.

8. The thermal sheet of claim 1, wherein the thermal layer includes a mixture of a graphite powder, a binder and a curing agent.

9. The thermal sheet of claim 8, the binder is at least one selected from the group consisting of a polyester resin, a urethane resin, an epoxy resin, an acrylic resin and a mixture thereof.

10. The thermal sheet of claim 8, wherein the curing agent is at least one selected from the group consisting of an epoxy resin curing agent having an oxirane group, a triglycidyl isocyanurate curing agent having an oxirane group, a curing agent having an isocyanate group, a curing agent having a blocked isocyanate group, a curing agent having a carboxylic end group, and an aliphatic or aromatic curing agent having an epoxide and/or anhydride reaction group.

11. The thermal sheet of claim 8, wherein the mixture further comprises a dispersing agent, a filler and a solvent.

12. The thermal sheet of claim 11, wherein the filler is at least one selected from the group consisting of Al₂O₃, Al, BN, Ag-coated Cu and a mixture thereof.

13. The thermal sheet of claim 11, wherein the dispersing agent is at least one selected from the group consisting of a polyamine amide based material, phosphoric acid ester based material, polyisobutylene, oleic acid, stearin acid, fish oil, ammonium salt of a polycarboxylic acid, sodium carboxy methyl and a mixture thereof.

14. The thermal sheet of claim 11, wherein the solvent is at least one selected from the group consisting of methyl ethyl ketone, ethanol, xylene, toluene, acetone, trichloroethane, butanol, methyl Isobuthyl ketone (MIBK), ethyl acetate (EA), butyl acetate, cyclo hexanone, water, propylene glycol mono methyl ether, MEK, anone and a mixture thereof.

15. An apparatus comprising:
a heat-generating device which generates heat;
a base film for transferring the heat of the heat-generating device, the base film including:
a plurality of protrusions at a first surface of the base film and extending along a first direction, and
a plurality of grooves between two adjacent protrusions as a heat flow path along the first direction; and
a thermal layer for thermally conducting and/or radiating the heat transferred from the base film, the thermal layer being disposed on the first surface of the base film.

16. The apparatus of claim 15, wherein a width of a central portion of at least one of the grooves is narrower than a width of an end portion of the at least one of the grooves.

17. The apparatus of claim 15, wherein the first direction is aligned with a heat flow direction inside the apparatus.

18. The apparatus of claim 15, further comprising a heat dissipater connected to the thermal layer, the heat transferred to the thermal layer being thermally conducted to the heat dissipater.

19. The apparatus of claim 18, wherein the heat dissipater is a heat sink.

20. The apparatus of claim 15, wherein the heat transferred to the thermal layer is thermally radiated to a medium surrounding the thermal layer.

21. The apparatus of claim 20, wherein the medium surrounding the thermal layer is air.

22. The apparatus of claim 15, wherein the thermal layer has thermal conductive particles therein.

23. The apparatus of claim 22, wherein the thermal conductive particles are at least one selected from the group consisting of Cu, Ag, Al and a mixture thereof.

24. The apparatus of claim 15, further comprising an adhesive layer disposed on a second surface of the base film opposite to the first surface of the base film, the adhesive layer being in contact with the heat-generating device.

25. The apparatus of claim 24, wherein the adhesive layer is a thermally conductive adhesive.

26. The apparatus of claim 15, wherein the thermal layer includes a mixture of a graphite powder, a binder and a curing agent.

27. The apparatus of claim 26, wherein the mixture further includes a dispersing agent, a filler and a solvent.

28. The apparatus of claim 15, wherein the heat-generating device is a display device.
